(19) United States
(12) Patent Application Publication
(10) Pub. No.: US 2025/0392247 A1
(43) Pub. Date: Dec. 25, 2025

(54) ANALOG TEMPERATURE BASED MOTOR SPEED CONTROL

(71) Applicant: Hamilton Sundstrand Space Systems International, Inc., Windsor Locks, CT (US)

(72) Inventors: Joshua Todd, Tolland, CT (US); Stephen Bosomworth, Broad Brook, CT (US); Nicholas Stoerm Van Derzee, Windsor Locks, CT (US)

(21) Appl. No.: 18/753,477

(22) Filed: Jun. 25, 2024

(51) Int. Cl. H02P 29/68; B64G 1/50; G01K 3/00; G01K 7/00; G01K 13/02; H02P 23/14

(52) U.S. Cl. CPC H02P 29/68; G01K 3/005; G01K 7/00; G01K 13/026; H02P 23/14; B64G 1/50

(57) ABSTRACT

A space-based vehicle includes at least one electrical system. The space-based vehicle also includes a cooling system having a coolant loop, a motor driven pump for driving a coolant through the coolant loop, and a radiator through which the coolant loop passes. A temperature sensor is disposed proximate the coolant loop and outputs an electrical signal, wherein a parameter of the electrical signal is dependent on a temperature of the coolant loop at the temperature sensor. An analog motor speed control circuit includes an input connected to the temperature sensor and an output connected to a motor speed regulator of a motor within the motor driven pump, and wherein the analog motor speed control circuit provides a motor control signal from the output and wherein characteristics of the motor speed control circuit depend on a magnitude of a signal received at the input connected to the temperature sensor.

### BACKGROUND

Exemplary embodiments pertain to the art of spacecraft electronics cooling, and more particularly to an analog coolant pump speed control circuit for adjusting a coolant pump speed based on a temperature.

Space-based applications such as satellites, deep-space probes, and other unmanned spacecraft, include electronic systems configured to perform mission operations. Due to the unique conditions encountered outside of the atmosphere such electronics can build up large amounts of waste heat and active cooling is used to remove the heat from the electronics. One example active cooling system used in unmanned spacecraft is a fluid cooling system that uses a pump to pass fluid through or adjacent to the electronics thereby causing the fluid to pick up heat. The fluid is then passed through one or more radiators and the picked up heat is radiated out of the spacecraft.

Rotation of the pump is driven by a motor. Conventionally, pump motors of this type are controlled by field programmable gate arrays, microcontrollers, or similar digital controller types. However, radiation and other environmental conditions in space can cause these active digital control systems to deteriorate and result in sub-optimal operations of the cooling systems.

### BRIEF DESCRIPTION

Disclosed is a space-based vehicle includes at least one electrical system. The space-based vehicle also includes a cooling system having a coolant loop, a motor driven pump configured to drive a coolant through the coolant loop, and a radiator through which the coolant loop passes. A temperature sensor is disposed proximate the coolant loop and is configured to output an electrical signal, wherein a parameter of the electrical signal is dependent on a temperature of the coolant loop at the temperature sensor. An analog motor speed control circuit includes an input connected to the temperature sensor and an output connected to a motor speed regulator of a motor within the motor driven pump, and wherein the analog motor speed control circuit provides a motor control signal from the output and wherein characteristics of the motor speed control circuit depend on a magnitude of a signal received at the input connected to the temperature sensor.

In one example of the above embodiment, the analog motor speed control circuit is characterized by an absence of microcontrollers and field programmable gate arrays (FPGAs).

In another example of any of the above embodiments the temperature sensor is disposed proximate a coolest portion of the coolant loop.

In another example of any of the above embodiments the coolest portion of the coolant loop is immediately upstream of the at least one electrical system.

In another example of any of the above embodiments the analog motor speed control circuit includes a temperature sensor integrator circuit connected to the input and configured to provide an integral output voltage to a temperature reference differential amplifier and a reference set point generator circuit configured to provide a reference voltage to the temperature reference differential amplifier. The temperature reference differential amplifier is configured to output an error signal dependent on a difference between the integral output voltage and the reference voltage and a motor speed control generator circuit configured to generate the motor control signal based on the error signal.

In another example of any of the above embodiments the analog speed control circuit further includes a differential amplifier disposed between the temperature sensor differential amplifier and the motor speed control generator circuit, wherein the differential amplifier is configured to amplify the error signal.

In another example of any of the above embodiments the analog speed control circuit further includes a speed detection circuit connected to the motor of the motor driven pump, wherein a detected speed is provided to a second comparator the second comparator having at least a maximum speed reference input, and an acceptable speed output configured to output 0 volts when the detected speed is equal to or greater than the maximum speed reference input.

In another example of any of the above embodiments the acceptable speed output is connected to the differential amplifier such that the differential amplifier drives the error signal to 0 when the acceptable speed output is 0 volts.

In another example of any of the above embodiments, the analog motor speed control circuit further includes a minimum speed reference input, and wherein the acceptable speed output is configured to output 0 volts when the detected speed is equal to or less than the minimum speed reference input.

In another example of any of the above embodiments the motor speed control generator circuit is configured to generate a nominal motor speed control signal and adjust the nominal motor speed control signal using the error signal.

Also disclosed is a method for controlling a motor speed of a space-based vehicle cooling system. The method includes measuring a temperature of a coolant in a coolant loop using a temperature sensor and outputting a temperature signal having a magnitude corresponding to the measured temperature, comparing the temperature signal to a reference temperature signal and generating an error signal corresponding to the difference between the temperature signal and the reference temperature signal, converting the error signal into a motor speed control signal offset, and applying the motor speed control signal offset to a motor speed control signal and driving a coolant pump motor of a coolant pump in the coolant loop using the offset motor speed control signal.

In another example of any of the above embodiments comparing the temperature signal to the reference temperature signal and generating the error signal corresponding to the difference between the temperature signal and the reference temperature signal, converting the error signal into the motor speed control signal offset and applying the motor speed control signal offset to a motor speed control signal is performed without the use of either of a microcontroller and a field programmable gate array (FPGA).

In another example of any of the above embodiments the temperature sensor is disposed at a coolest location of the coolant loop.

In another example of any of the above embodiments the coolest location of the coolant loop is immediately upstream of a set of cooled electronic systems.

In another example of any of the above embodiments the method further includes monitoring a speed of the coolant pump motor, comparing the speed to a maximum speed reference point, and setting the motor speed control signal offset to 0 in response to the speed of the coolant pump motor meeting or exceeding the maximum speed reference point.

In another example of any of the above embodiments the method further includes comparing the speed to a minimum speed reference point, and setting the motor speed control signal offset to 0 in response to the speed of the coolant pump motor being equal to or less than the minimum speed reference point.

In another example of any of the above embodiments outputting a temperature signal having a magnitude corresponding to the measured temperature comprises integrating a sensor signal over a predefined time period and providing the integrated sensor signal as the temperature signal.

In another example of any of the above embodiments outputting a temperature signal having a magnitude corresponding to the measured temperature, comparing the temperature signal to a reference temperature signal and generating an error signal corresponding to the difference between the temperature signal and the reference temperature signal, and converting the error signal into a motor speed control signal offset is performed using an analog motor speed control circuit includes a temperature sensor integrator circuit connected to the input and configured to provide an integral output voltage to a temperature reference differential amplifier, a reference set point generator circuit configured to provide a reference voltage to the temperature reference differential amplifier, the temperature reference differential amplifier configured to output an error signal dependent on a difference between the integral output voltage and the reference voltage, and a motor speed control generator circuit configured to generate the motor control signal based on the error signal.

In another example of any of the above embodiments, the method further includes a differential amplifier disposed between the first comparator and the motor speed control generator circuit, wherein the differential amplifier is configured to amplify the error signal.

In another example of any of the above embodiments applying the motor speed control signal offset to the motor speed control signal increases the motor speed when the temperature signal exceeds the reference temperature and decreases the motor speed when the temperature signal is below the reference temperature.

### BRIEF DESCRIPTION OF THE DRAWINGS

The following descriptions should not be considered limiting in any way. With reference to the accompanying drawings, like elements are numbered alike:

FIG. 1 is schematic representation of an unmanned spacecraft;

FIG. 2 is a schematic representation of an analog cooling pump motor speed control circuit;

FIG. 3 is a detailed electrical schematic of one circuit capable of operating as the analog cooling pump motor speed control circuit; and

FIG. 4 is a practical operation flow of the cooling system of the spacecraft of FIG. 1.

### DETAILED DESCRIPTION

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Unmanned spacecraft, such as satellites and deep space probes, include cooling systems operated by driving a fluid through a coolant loop using a motor. Existing systems typically utilize fixed-speed control loops without the ability to adjust or otherwise alter the speed at which the motor is operated. For extended duration missions (e.g., 10-15 years or longer), temperature and radiation drift, as well as general mechanical wear on the spacecraft systems can lead to decreased controller and motor performance. This can, in turn, decrease or otherwise impact the flowrate of coolant flowing through the cooling system. Similarly, if the system experiences an abnormally prolonged temperature extreme (either hot or cold) during the mission, the coolant driven at nominal flowrates may be too fast or too slow to compensate for the extended extreme.

This inflexibility can be remediated by including an adjustable speed control circuit able to adapt the speed of the motor, and thus the rate at which coolant is driven through the system. However, due to the unique environmental conditions of space, adjustable speed controls including digital devices (e.g., field programmable gate arrays and microcontrollers) are not reliable. By incorporating a temperature sensor into the system, and using an analog motor speed control circuit to generate a motor speed control signal based on the temperature of the coolant, a larger range of required coolant speeds can be utilized. This, in turn, can give rise to a longer operational life cycle of the spacecraft.

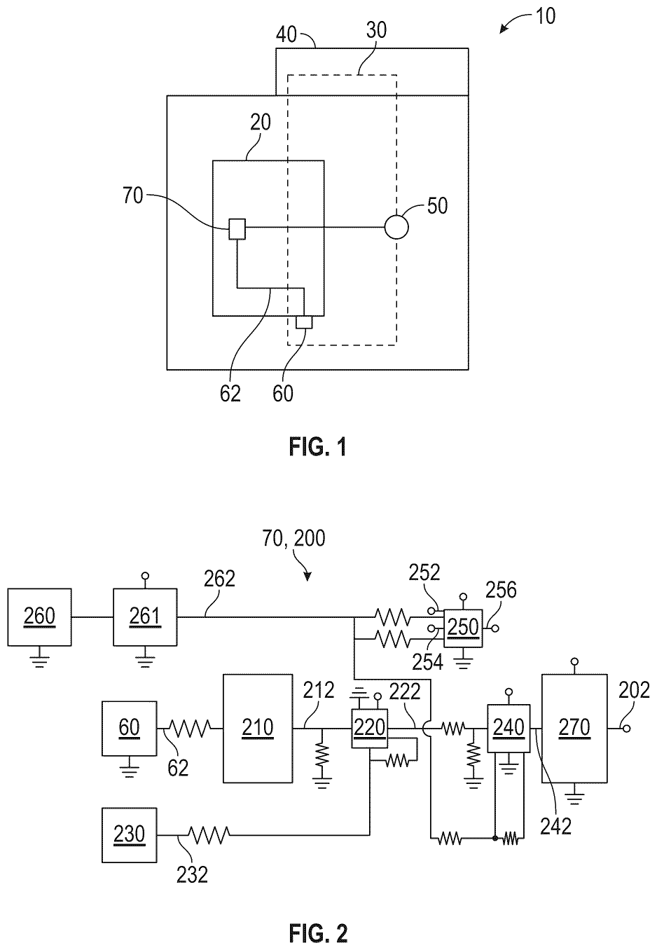

FIG. 1 illustrates an exemplary spacecraft 10 including an electrical systems 20 and a coolant loop 30. A radiator 40 extends outward from the body of the spacecraft 10. The coolant loop 30 interfaces with the electrical systems 20 and passes through the radiator 40. Fluid, such as a liquid coolant, is driven along the coolant loop 30 by a coolant pump 50. The coolant pump 50 includes a three-phase brushless DC motor, which drives rotation of the coolant pump 50 and the rotation of the coolant pump 50 in turn drives the fluid along the coolant loop 30.

A temperature sensor 60 is positioned proximate the coolant loop 30 and measures a temperature of the coolant flowing through the coolant loop. In alternate examples, the temperature sensor 60 can be integrated directly into the coolant loop 30 instead of being positioned proximate the coolant loop 30. A temperature output 62 is provided from the temperature sensor 60 to an analog motor speed control circuit 70. The analog motor speed control circuit 70 converts the output 62 into a motor control signal which sets the speed of the motor, and thereby the speed at which fluid is driven through the coolant loop 30.

In the illustrated example, the temperature sensor 60 is positioned at the coldest point of the coolant loop 30. In some examples, the coldest point in the coolant loop 30 is immediately prior to the coolant loop 30 mechanical interface with the electrical systems 20.

During operation, the temperature sensor 60 generates an offset voltage, with the offset voltage being a function of the measured temperature. The offset voltage is provided to a motor control feedback loop via the motor speed control circuit 70 and offsets the magnitude of the feedback loop by a corresponding amount. As the temperature of the coolant in the cooling loop 30 changes, the offset voltage changes, and the feedback voltage provided to a pulse width modulation (PWM) control of the motor within the pump 50 is adjusted. The PWM control reads the feedback and provides a corresponding adjustment to motor speed output signal.

In addition to the feedback control loop, a pair of discrete hardware limits set a high speed and a low speed that bound the possible speed ranges, thereby ensuring that the motor continues operating at all times and does not fall outside of a designed operating window even when exposed to extended extremes. One of skill in the art can determine the appropriate operating window(s) for a given system based on the particular electronics and cooling systems being implemented and use case in which the spacecraft is expected to be operated.

Integrating this control loop into the spacecraft allows for a more common-controller architecture systems for a singular applications, allowing for greater flexibility. In some examples, the operating window of a given system can be adjusted using jumpers to implement larger, or narrower, speed control ranges, allowing for a common architecture of the motor speed control circuit 70 to be deployed throughout multiple distinct systems. In some cases, this architecture enables the use of less expensive analog controllers in systems which previously required more expensive digital controllers or in systems that were previously unable to be controlled due to the particularities of spaceflight. In addition, the total system power consumption is lower than an FPGA or microcontroller based controllers, freeing up spacecraft power and allowing for more flexibility or for additional features to be implemented.

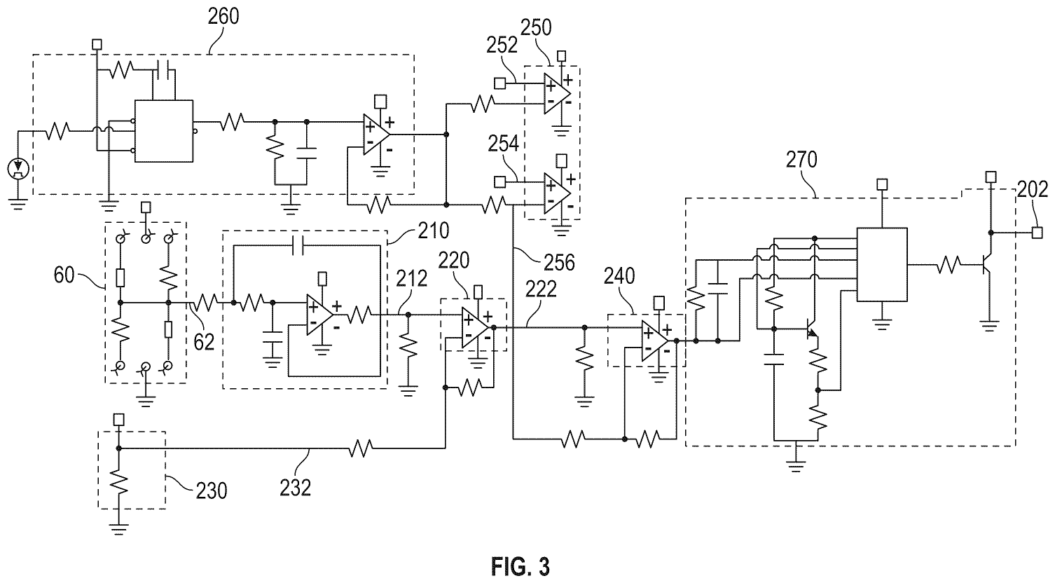

With continued reference to the spacecraft 10 of FIG. 1, FIG. 2 illustrates a schematic view of one exemplary analog circuit 200 for generating a motor speed control output 202 based on the output 62 of the temperature sensor 60. FIG. 3 illustrates one exemplary circuit level schematic for implementing the schematic view of FIG. 2. It is appreciated that alternative circuits may be implemented to achieve the same functions, and that the specific resistances, inductances, voltage magnitudes, current magnitudes, and other parameters, are device specific and can be determined by one of skill in the art based on the needs and parameters of the spacecraft 10 in which the circuit is implemented.

The output 62 is provided to a temperature sensor integrator 210 which generates a long time-constant integral of the output temperature and provides the integral as an output 212 to a temperature reference differential amplifier 220.

A nominal high precision reference set point generator 230 outputs a voltage signal 232 to the temperature reference differential amplifier 220. The voltage signal 232 corresponds to a nominal operating point for the temperature such that when the coolant is at the ideal temperature, the output 212 of the integrator 210 and the voltage signal 232 are identical.

The temperature reference differential amplifier 220 determines a difference between the output 212 of the integrator and the voltage signal 232, and provides an error output 222 equal to the difference. The error output 222 is then provided to a speed control differential amplifier 240.

A hall effect device 260 delivers a frequency signal corresponding to the speed at which the motor within the pump 50 is rotating to speed decoder circuit 261 which converts the speed to a speed voltage signal 262 to a pair of comparators in an operational bounds module 250. A high speed set point 252 and a low speed set point 254 are each provided to corresponding comparators within the operational bounds module 250. The operational bounds module 250 includes a logical ordering such that when the detected motor speed exceeds the high speed set point 252 or falls below the low speed set point 254, the module 250 outputs a 0 voltage on the limit bound 256, and in all other cases the module 250 outputs a high voltage (e.g. 5V) on the limit bound signal 256. When the limit bound signal 256 is 0 voltage, indicating that the motor speed is at the edge of the operational window defined by the low speed set point 252 and the high speed set point 254, the speed control differential amplifier 240 sets the error to 0 preventing the speed of the motor from being altered. This, in turn, locks the speed to possible speed ranges within the operational window.

The speed voltage signal 262 is additionally provided to the speed control differential amplifier 240. The speed control differential amplifier 240 determines a difference between the error output 222 of the temperature reference differential amplifier 220 and the speed voltage signal 262 and provides speed correction signal 242 equal to the difference. The speed correction signal 242 is then provided to the motor speed control generator 270.

The motor speed control generator 270 generates a nominal (standard) speed control signal configured to drive the motor at a nominal speed. The speed correction signal 242 operates as an offset that is applied to the nominal speed control signal, thereby decreasing or increasing the total speed control signal, and decreasing or increasing the speed at which the motor is driven by a corresponding amount. The combined nominal speed control signal and speed correction signal 242 is output from the motor speed control circuit 70, 200 at a speed control output 202 and provided to the motor.

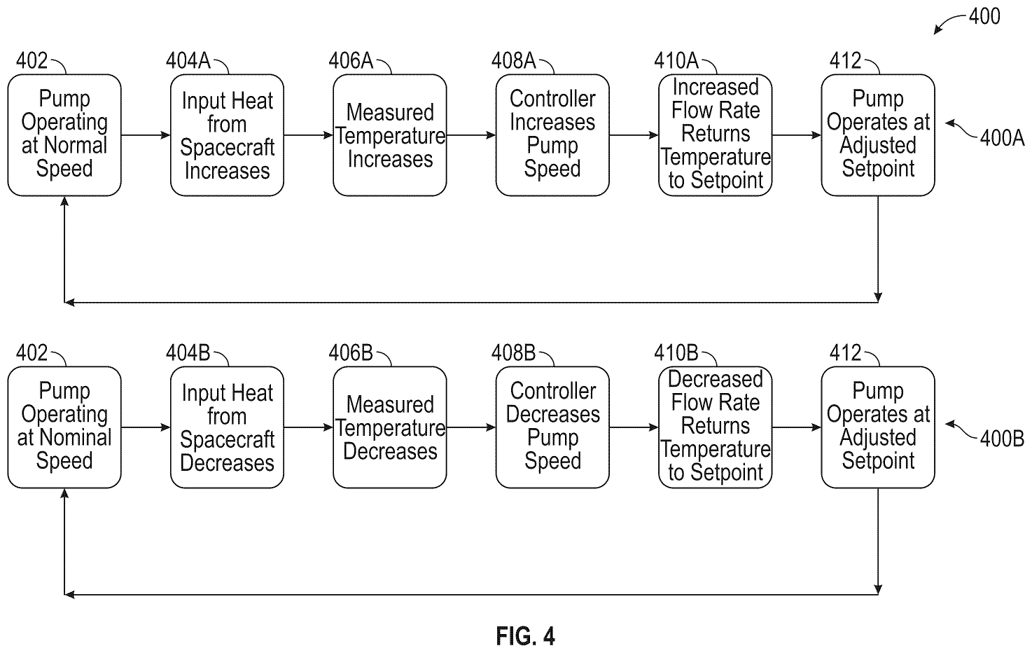

With continued reference to FIGS. 1-3, FIG. 4 illustrates an exemplary functional flow 400 of the spacecraft 10 cooling system including the motor speed control circuit 70 in exemplary operations, with a first operation (functional flow 400A) occurring when the temperature sensor 60 indicates an increased heat, and the second operation (functional flow 400B) occurring when the temperature sensor 60 indicates a decreased heat.

Initially, the pump 50 is driven at a nominal speed by the motor in a pump operating at nominal speed step 402. The actual heat of the spacecraft 10 changes at either an input heat from spacecraft increases step 404A or an input heat from spacecraft decreases step 404B. The change in heat is registered by the temperature sensor 60 in a measured temperature increases step 406A or a measured temperature decreases step 406B. The change in measured temperature is passed through the motor speed control circuit 70 which provides a corresponding alteration to the pump speed in a controller increases pump speed step 408A or a controller decreases pump speed step 408B. The pump speed change causes a corresponding flow rate change in coolant passing through the coolant loop 30 and returns the temperature to the setpoint temperature in either an increased flow rate returns temperature to setpoint step 410A or a decreased flow rate returns temperature to setpoint step 410B.

Once the temperature has returned to the setpoint, the speed is held as the new nominal speed until the temperature changes again in a pump operates at adjusted setpoint step 412.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A space-based vehicle comprising:
at least one electrical system;
a cooling system including a coolant loop, a motor driven pump configured to drive a coolant through the coolant loop, and a radiator through which the coolant loop passes;
a temperature sensor disposed proximate the coolant loop and configured to output an electrical signal, wherein a parameter of the electrical signal is dependent on a temperature of the coolant loop at the temperature sensor;
an analog motor speed control circuit including an input connected to the temperature sensor and an output connected to a motor speed regulator of a motor within the motor driven pump, and wherein the analog motor speed control circuit provides a motor control signal from the output and wherein characteristics of the motor speed control circuit depend on a magnitude of a signal received at the input connected to the temperature sensor.

2. The space-based vehicle of claim 1, wherein the analog motor speed control circuit is characterized by an absence of microcontrollers and field programmable gate arrays (FPGAs).

3. The space-based vehicle of claim 1, wherein the temperature sensor is disposed proximate a coolest portion of the coolant loop.

4. The space-based vehicle of claim 3, wherein the coolest portion of the coolant loop is immediately upstream of the at least one electrical system.

5. The space-based vehicle of claim 1, wherein the analog motor speed control circuit comprises:
a temperature sensor integrator circuit connected to the input and configured to provide an integral output voltage to a temperature reference differential amplifier;
a reference set point generator circuit configured to provide a reference voltage to the temperature reference differential amplifier;
the temperature reference differential amplifier configured to output an error signal dependent on a difference between the integral output voltage and the reference voltage; and
a motor speed control generator circuit configured to generate the motor control signal based on the error signal.

6. The space-based vehicle of claim 5, further comprising a differential amplifier disposed between the temperature sensor differential amplifier and the motor speed control generator circuit, wherein the differential amplifier is configured to amplify the error signal.

7. The space-based vehicle of claim 5, further comprising a speed detection circuit connected to the motor of the motor driven pump, wherein a detected speed is provided to a second comparator the second comparator having at least a maximum speed reference input, and an acceptable speed output configured to output 0 volts when the detected speed is equal to or greater than the maximum speed reference input.

8. The space-based vehicle of claim 7, wherein the acceptable speed output is connected to the differential amplifier such that the differential amplifier drives the error signal to 0 when the acceptable speed output is 0 volts.

9. The space-based vehicle of claim 7, further comprising a minimum speed reference input, and wherein the acceptable speed output is configured to output 0 volts when the detected speed is equal to or less than the minimum speed reference input.

10. The space-based vehicle of claim 5, wherein the motor speed control generator circuit is configured to generate a nominal motor speed control signal and adjust the nominal motor speed control signal using the error signal.

11. A method for controlling a motor speed of a space-based vehicle cooling system comprising:
measuring a temperature of a coolant in a coolant loop using a temperature sensor and outputting a temperature signal having a magnitude corresponding to the measured temperature;
comparing the temperature signal to a reference temperature signal and generating an error signal corresponding to the difference between the temperature signal and the reference temperature signal;
converting the error signal into a motor speed control signal offset; and
applying the motor speed control signal offset to a motor speed control signal; and
driving a coolant pump motor of a coolant pump in the coolant loop using the offset motor speed control signal.

12. The method of claim 11, wherein comparing the temperature signal to the reference temperature signal and generating the error signal corresponding to the difference between the temperature signal and the reference temperature signal, converting the error signal into the motor speed control signal offset and applying the motor speed control signal offset to a motor speed control signal is performed without the use of either of a microcontroller and a field programmable gate array (FPGA).

13. The method of claim 11, wherein the temperature sensor is disposed at a coolest location of the coolant loop.

14. The method of claim 13, wherein the coolest location of the coolant loop is immediately upstream of a set of cooled electronic systems.

15. The method of claim 11, further comprising monitoring a speed of the coolant pump motor, comparing the speed to a maximum speed reference point, and setting the motor speed control signal offset to 0 in response to the speed of the coolant pump motor meeting or exceeding the maximum speed reference point.

16. The method of claim 15, further comprising comparing the speed to a minimum speed reference point, and setting the motor speed control signal offset to 0 in response to the speed of the coolant pump motor being equal to or less than the minimum speed reference point.

17. The method of claim 11, wherein outputting a temperature signal having a magnitude corresponding to the measured temperature comprises integrating a sensor signal over a predefined time period and providing the integrated sensor signal as the temperature signal.

18. The method of claim 11, wherein outputting a temperature signal having a magnitude corresponding to the measured temperature, comparing the temperature signal to a reference temperature signal and generating an error signal corresponding to the difference between the temperature signal and the reference temperature signal, and converting the error signal into a motor speed control signal offset is performed using an analog motor speed control circuit comprising:
a temperature sensor integrator circuit connected to the input and configured to provide an integral output voltage to a temperature reference differential amplifier;
a reference set point generator circuit configured to provide a reference voltage to the temperature reference differential amplifier;
the temperature reference differential amplifier configured to output an error signal dependent on a difference between the integral output voltage and the reference voltage; and
a motor speed control generator circuit configured to generate the motor control signal based on the error signal.

19. The method of claim 18, further comprising a differential amplifier disposed between the first comparator and the motor speed control generator circuit, wherein the differential amplifier is configured to amplify the error signal.

20. The method of claim 11, wherein applying the motor speed control signal offset to the motor speed control signal increases the motor speed when the temperature signal exceeds the reference temperature and decreases the motor speed when the temperature signal is below the reference temperature.
